(19) United States
(12) Patent Application Publication
(10) Pub. No.: US 2011/0246983 A1
(43) Pub. Date: Oct. 6, 2011

(54) Wireless Network Backup Device and Method

(75) Inventors: Jeffrey Brunet, Richmond Hill (CA); Yousuf Chowdhary, Maple (CA); Alex Lemelev, Thornhill (CA)

(73) Assignee: Storage Appliance Corporation, Richmond Hill (CA)

(21) Appl. No.: 13/076,832

(22) Filed: Mar. 31, 2011

Related U.S. Application Data
(60) Provisional application No. 61/341,532, filed on Apr. 1, 2010.

(51) Int. Cl. G06F 15/16; G06F 9/445

(52) U.S. Cl. 717/178; 709/219

(57) ABSTRACT

A system and method is provided for automatically backing up one or more computers to a wireless backup device either across a pre-existing wireless network if one is in use by the one or more computers or across a newly formed wireless network if a pre-existing wireless network is not in use by the one or more computers. The backup operation is performed by a software application provided by the wireless backup device which application can be launched, installed and configured on the one or more computers automatically and without user input via an initial hardwired connection between the wireless backup device and the one or more computers.

### CROSS-REFERENCE TO RELATED APPLICATIONS

This application claims the benefit of U.S. Provisional Patent Application No. 61/341,532 filed on Apr. 1, 2010 and entitled “Method and a System for a Wireless Network Backup Device,” which is incorporated herein by reference in its entirety.

### BACKGROUND OF THE INVENTION

1. Field of the Invention

The present invention relates generally to performing data backup operations across a computer network.

2. Description of the Prior Art

The creation and value of personal digital content is dramatically increasing as people acquire new digital devices. In private households and in businesses, there are increasingly large collections of digital data. Digital photos stored on a PC have replaced shoeboxes full of family photos. Moving Picture Experts Group Audio Layer 3 (MP3) music collections have displaced shelves of Compact Discs (CDs) or vinyl records. Digital video and Personal Video Recorder (PVR)-recorded television are poised to replace videotape collections. The devices generating the digital files have become more sophisticated and therefore the resultant data file sizes have become significantly larger. The amount of digital data that people have has risen dramatically in recent years and, with this rise, there has been an attendant increase in the need for simple data backup.

The revolution in digital data has swept through faster than backup options have been able to mature. Personal Computer (PC) storage has notorious vulnerabilities. Almost everyone who owns a PC has experienced the loss of data.

Existing backup solutions, developed mostly for the corporate market, are expensive, bulky and overly complicated. For an everyday consumer the electronic data backup process is not easy and not everyone is technically savvy enough to use the current backup products. A need exists for an extremely simple, fully automated, and affordable backup appliance for digital data. Considering the impact of possibly losing irreplaceable family photos and documents due to computer failures, virus, theft or disasters, a user may want to have a copy of personal electronic data files in another device or location. Storing data with an online service provider is one option to have data redundancy or having a central device connected to the local area network is another option.

Thus one strategy for data backup is to use online data storage backup services offered by companies offering remote data storage facilities. In this way, instead of making copies of data locally, a user can opt to have the backed up data stored on a remote server using the internet for file transfer. Typically the user is required to sign up with a service provider and pay a monthly fee for storage of the backed up data or to obtain a copy of the backed up data for purposes of restoring lost or damaged data. It also requires having to install the provider's software and high speed internet connectivity to facilitate the rapid transfer of files. These services typically charge monthly or yearly fees based on the amount of data being backed up. While there are advantages to the online remote backup since the servers are located away from the home with lower risk of losing data to theft or disaster, such services can be a very expensive option for large amounts of data.

In a case where a user has multiple computers and wants to back them up there are some ways, though none that are very convenient. One example is having an external hard drive based backup device that connects to the computer via a Universal Serial Bus (USB) port and may have backup software on the backup drive itself. Thus a user can connect the backup device to the computer and it will be backed up to the device. But in the case of multiple computers the user is required to carry out this process with each of the computers one after the other. Thus if a user forgets to connect the backup device to a particular computer for an extended duration and the computer fails the data that was created during this period is lost.

Alternatively, a user may want to backup all data from different computers in an office or home to one central but local device so that data can be uniformly accessed from any computer. Typically a Network Attached Storage (NAS) tills this role by being plugged into the Ethernet port of the router of a local area network. A traditional NAS device is relatively expensive and requires complicated configuration which is beyond the knowledge and abilities of a typical user. Further, it requires that the accompanying software be installed on each of the computers connected to the local area network (LAN) that need to be backed up.

A NAS unit is essentially a self-contained stripped down computer connected to a network, with the sole purpose of providing data storage services to other devices on the network. NAS units usually do not have a keyboard or display, and are controlled and configured over the network, often by connecting via an internet browser to their network (IP) address. A general-purpose operating system is not needed on a NAS device, and often minimal-functionality or stripped-down operating systems are used instead.

The NAS contains a network card with an Ethernet port which allows it to be connected to an Ethernet port of a router. A NAS maintains its own Internet Protocol (IP) address comparable to a computer and other Transmission Control Protocol/Internet Protocol (TCP/IP) devices. Using a software program that normally is provided together with the NAS hardware, a user can set up automatic or manual backups and file copies between the NAS and other network connected computers.

Additionally the software installed on each computer to be backed up needs to be manually configured in terms of specifying where the data to be backed up is located, what data is to be backed up and how often to backup the data.

What is needed therefore is a simplified data backup solution that can backup one or more computers without requiring all the cost, complexity and user input of known solutions.

### SUMMARY

In one example is a data backup method comprising: automatically and without user input installing and configuring a backup software application on a first computer; scanning the first computer using the backup software application to determine whether the first computer has a configured pre-existing wireless infrastructure network connection in use by the first computer to a pre-existing wireless infrastructure network; establishing a wireless network connection between a wireless backup device and the pre-existing wireless infrastructure network if the first computer has a configured pre-existing wireless infrastructure network connection in use by the first computer; creating a newly formed wireless network if the first computer does not have a configured pre-existing wireless infrastructure network connection in use by the first computer; establishing a wireless network connection between the wireless backup device and the first computer via the newly formed wireless network if the first computer does not have a configured pre-existing wireless infrastructure network connection in use by the first computer; automatically and without user input backing up data from the first computer to the wireless backup device across the established wireless network connection between the wireless backup device and the pre-existing wireless infrastructure network using the backup software application if the first computer has a configured pre-existing wireless infrastructure network connection in use by the first computer; and automatically and without user input backing up data from the first computer to the wireless backup device across the established wireless network connection between the wireless backup device and the first computer via the newly formed wireless network using the backup software application if the first computer does not have a configured pre-existing wireless infrastructure network connection in use by the first computer.

In another example is a method of computer data backup comprising: automatically and without user input launching, installing and configuring a backup software application from a wireless backup device to a first computer upon detection by the first computer of a wired connection between the wireless backup device and the first computer; automatically and without user input launching, installing and configuring the backup software application from the wireless backup device to a second computer upon detection by the second computer of a wired connection between the wireless backup device and the second computer; automatically and without user input backing up data from the first computer and the second computer to the wireless backup device across a pre-existing wireless infrastructure network using the backup software application if the first computer and the second computer each have a configured pre-existing wireless infrastructure network connection in use; and automatically and without user input backing up data from the second computer to the wireless backup device across the established wireless network connection between the wireless backup device and the second computer via the newly formed wireless network using the backup software application if the second computer does not have a configured pre-existing wireless infrastructure network connection in use by the second computer.

In still another example is a non-transitory computer readable medium containing programming code executable by a processor, the programming code configured to perform a method comprising; automatically and without user input installing and configuring a backup software application on a first computer; scanning the first computer using the backup software application to determine whether the first computer has a configured pre-existing wireless infrastructure network connection in use by the first computer to a pre-existing wireless infrastructure network; establishing a wireless network connection between a wireless backup device and the pre-existing wireless infrastructure network if the first computer has a configured pre-existing wireless infrastructure network connection in use by the first computer; creating a newly formed wireless network if the first computer does not have a configured pre-existing wireless infrastructure network connection in use by the first computer; establishing a wireless network connection between the wireless backup device and the first computer via the newly formed wireless network if the first computer does not have a configured pre-existing wireless infrastructure network connection in use by the first computer; automatically and without user input backing up data from the first computer to the wireless backup device across the established wireless network connection between the wireless backup device and the pre-existing wireless infrastructure network using the backup software application if the first computer has a configured pre-existing wireless infrastructure network connection in use by the first computer; and automatically and without user input backing up data from the first computer to the wireless backup device across the established wireless network connection between the wireless backup device and the first computer via the newly formed wireless network using the backup software application if the first computer does not have a configured pre-existing wireless infrastructure network connection in use by the first computer.

### BRIEF DESCRIPTION OF DRAWINGS

FIG. 1 is a block diagram of serially connecting a wireless backup device to more than one computer via a wired connection according to one embodiment.

FIG. 2 is a block diagram of a wireless backup device wirelessly connected to a pre-existing wireless infrastructure network according to one embodiment.

FIG. 3 is a block diagram of a wireless backup device wirelessly connected to one or more computers via a newly-formed ad hoc or access point network according to one embodiment.

FIG. 4 is a flow chart diagram of installing backup software on a computer from a wireless backup device according to one embodiment.

FIG. 5 is a flow chart diagram of wirelessly backing up data from a computer to a wireless backup device according to one embodiment.

FIG. 6 is a flow chart diagram of avoiding conflicts between one or more computers wirelessly backing up data to a wireless backup device according to one embodiment.

FIG. 7 is a block diagram of the components of a wireless backup device according to one embodiment.

### DETAILED DESCRIPTION OF THE INVENTION

A system and method is provided for automatically backing up one or more computers across a pre-existing or newly formed wireless network to a wireless backup device with little or no user input required.

In one embodiment, the wireless backup device is a memory device and associated hardware containing software that once installed on one or more computers will perform a backup of data from the one or more computers across a pre-existing wireless infrastructure network (e.g., a Local Area Network (LAN)), a newly formed wireless ad hoc network or a newly formed wireless access point network as will be explained. The software can be launched automatically via an optional emulation component contained within the wireless backup device as described in U.S. Pat. No. 7,813,913 (published as US 2007/0083354) and U.S. Pat. No. 7,818,160 (published as US 2007/0083355) each of which is incorporated by reference herein in its entirety. Alternatively, the software can be included on a portion of the wireless backup device to be manually launched by a user of the device, can be included on a non-transitory computer readable medium such as an optical disc which may be, e.g., a Compact Disc Read Only Memory (CD-ROM) or a Digital Versatile Disc (DVD), that is physically separate from the wireless backup device itself but that will launch when inserted into a player of a computer, or can be downloaded from another computer such as a web server accessible across a network such as the internet. However, regardless of implementation and whether the software will be automatically launched or will require some user involvement, the backup software in combination with the wireless backup device can still automatically and without user input perform the functionalities of installation and configuration to perform a backup operation of one or more computers in an automated fashion thus eliminating the need for user input to accomplish such functionality.

It is to be understood that, in the present specification, launching software is the process of initiating the running of some executable program code, one previously existing example of which occurs when a user double-clicks on an “.exe” file to begin the program code execution (and it is to be further understood that launching herein does not refer to merely starting the running of some program code already installed on a computer). Launching is in contrast to, again in the context of the present specification, installation and configuration, which are the processes of placing executable code onto a computer for the purposes of execution which typically involves providing Information about the program code to an operating system of the computer, etc., and making various settings and programmatic changes to enable the intended operation of the executable code within the computer as is known in the art.

In one embodiment the wireless backup device preferably has a memory device that has more than one partition on it. One partition is formatted like a CD-ROM and emulates an autorun device. The other partition is used for data backup. Thus when the wireless backup device is connected to a computer the computer enumerates two separate devices: a CD-ROM and, e.g., a hard drive. The CD-ROM partition contains the software and an autorun.inf file. When the backup device is connected to the computer it reads the autrun.inf file and launches the software to which the autorun.inf file points.

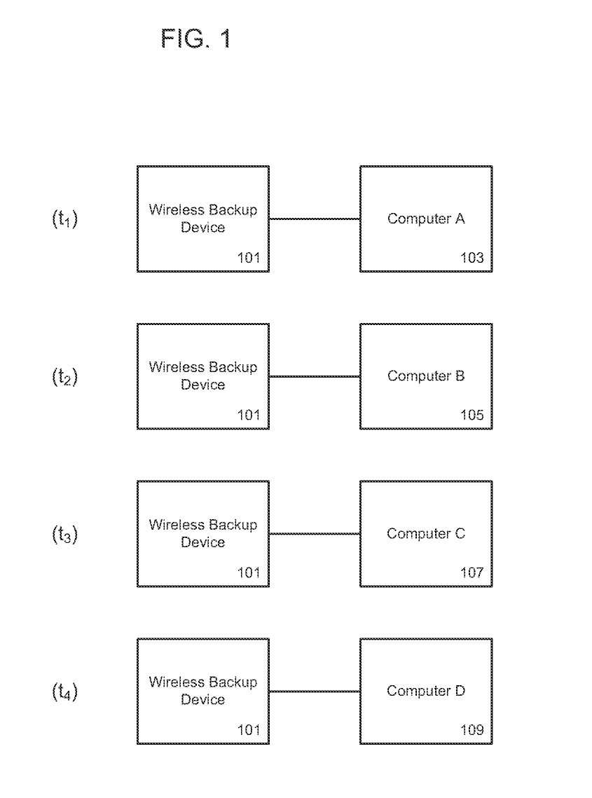

Referring now to FIG. 1 and using the wireless backup device with the emulation component as an exemplary embodiment, a user connects a wireless backup device 101 to a computer 103 (denoted Computer A) via a hardwired connection which triggers the launch, installation and configuration of software on computer 103 which performs a backup operation of data from computer 103 to wireless backup device 101. The user then connects wireless backup device 101 to a computer 105 (denoted Computer B) via a hardwired connection which triggers the launch, installation and configuration of software on computer 105 which performs a backup operation of data from computer 103 to wireless backup device 101. This is repeated for other computers such as computer 107 (denoted Computer C) and computer 109 (denoted Computer D). In this way, the backup application software is automatically launched, installed and configured on each computer which, in this embodiment, is then initially backed up via the hardwired connection to the wireless backup device. Further, while not shown in FIG. 1 but as will be explained, wireless backup device 101 can then perform incremental backup operations of one or more of computers 103-109 across a wireless connection. In an alternative embodiment the hardwired connection is used for the launch, installation and configuration operations but not for the initial backup operation thus leaving the initial backup operation, as well as any incremental backup operations, to instead be performed via the wireless connection.

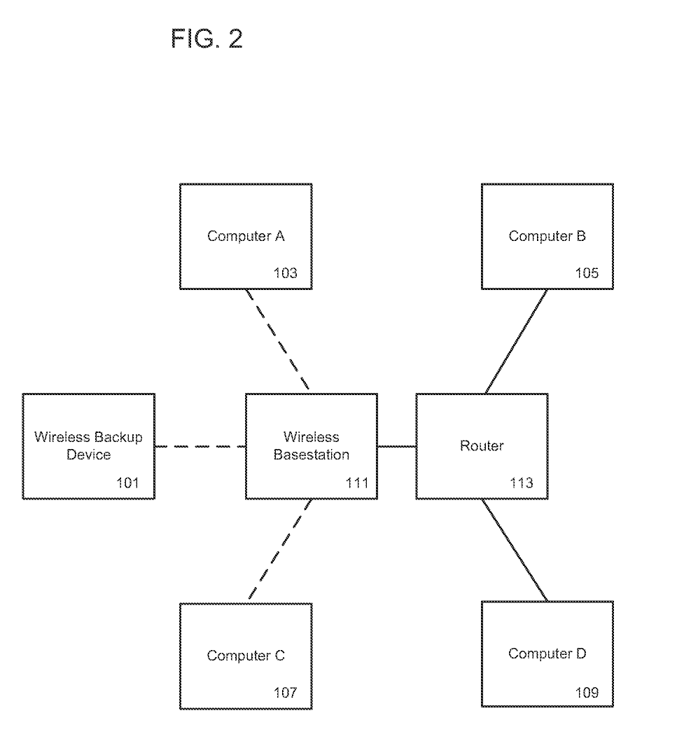

After the operations described with reference to FIG. 1, the use of wireless backup device 101 to perform backup operations via a pre-existing wireless infrastructure network will now be explained with reference to FIG. 2 according to one embodiment. Wireless backup device 101 connects to the pre-existing wireless infrastructure network by establishing a wireless connection to a wireless basestation 111 which is connected to a router 113 each of which typically are part of a pre-existing wireless infrastructure network. As shown in the figure, also wirelessly connected to wireless basestation 111 are computer 103 and computer 107. As also shown in the figure, connected via a hardwire connection to router 113 are computer 105 and computer 109 thereby also connecting computer 105 and computer 109 to the pre-existing wireless infrastructure network via basestation 111. In this way, wireless backup device 101 can communicate with each of computer 103-109 across the pre-existing wireless infrastructure network to perform the various backup operations described herein.

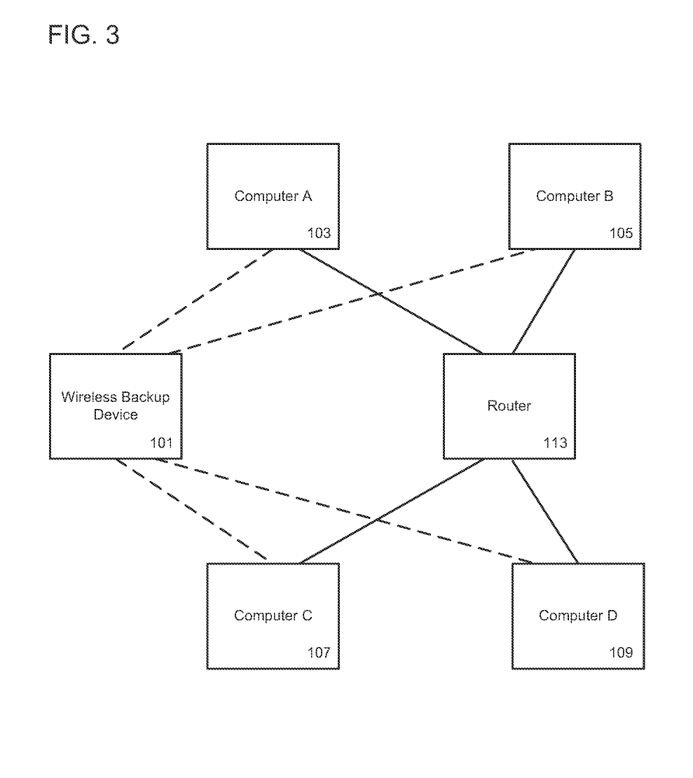

Similarly after the operations described with reference to FIG. 1, the use of wireless backup device 101 to perform backup operations via a newly formed wireless ad hoc network or a newly formed wireless access point network will now be explained with reference to FIG. 3 according to one embodiment. As shown, wireless backup device 101 connects to each of computers 103-109 via a wireless connection in either a newly formed wireless ad hoc network or a newly formed wireless access point network as will be explained. This is in contrast to the wireless connection shown and described with respect to FIG. 2 which uses wireless basestation 111 to communicate across a pre-existing wireless infrastructure network for communication between wireless backup device 101 and computers 103-109.

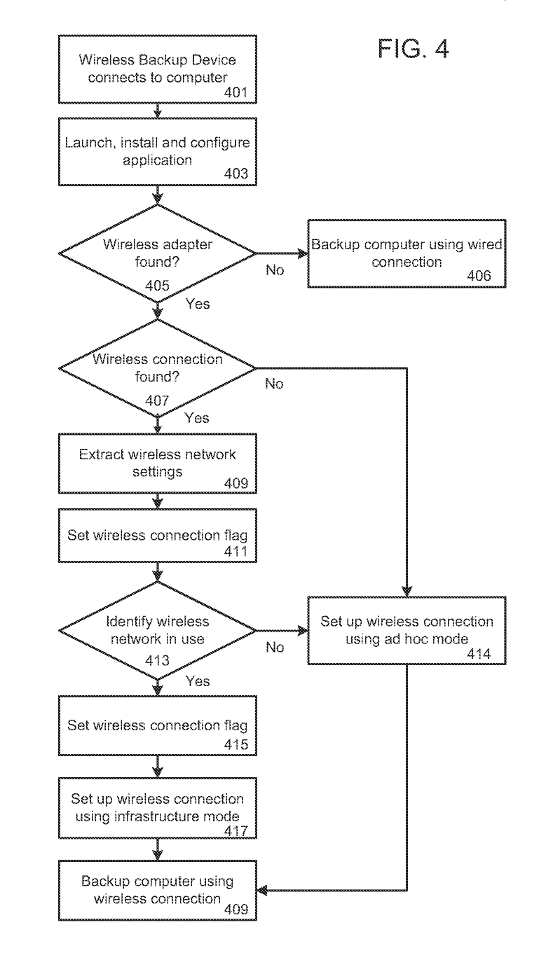

Referring now to FIG. 4, an exemplary method of some portions of the operations described with reference to FIGS. 1-3 according to one embodiment will now be described. In step 401, wireless backup device 101 is connected via a hardwire connection to a computer such as computer 103 as was described with reference to FIG. 1. In step 403, a backup application is launched, configured and installed on computer 103 which may be via an autorun operation and functionality or any of the other methods and functionalities described above. The backup application scans computer 103 for a wireless network adapter card or logic. If, in decision block 405, a wireless network adapter card is not found on computer 103 then computer 103 is backed up to wireless backup device 101 using the wired connection. Alternatively, if in decision block 405, a wireless network adapter card is found on computer 103 then the backup application scans computer 103 for a configured pre-existing wireless infrastructure connection. If, in decision block 407, a configured pre-existing wireless infrastructure connection is not found, then wireless backup device 101 sets up a newly formed wireless ad hoc network connection with computer 103 in step 414. Alternatively, if in decision block 407, a configured pre-existing wireless infrastructure connection is found, then the backup application extracts the wireless network settings from computer 103, as will be explained, and saves them onto wireless backup device 101, in step 409, and sets a wireless connection flag for computer 103 within wireless backup device 101 in step 411. The backup application then scans computer 103 to identify whether a pre-existing wireless infrastructure network is in use. If, in decision block 413, no pre-existing wireless infrastructure network in use has been identified, then wireless backup device 101 sets up a newly formed wireless ad hoc network connection with computer 103 in step 414. Alternatively, if in decision block 413, a pre-existing wireless infrastructure network in use has been identified, then wireless backup device 101 sets up a wireless connection with the pre-existing wireless infrastructure network in step 417. Then, in step 419, the backup application backs up files from computer 103 to wireless backup device 101 using whichever wireless connection has been established, that is, either the wireless connection of the pre-existing wireless infrastructure network or the newly formed wireless ad hoc network connection with computer 103.

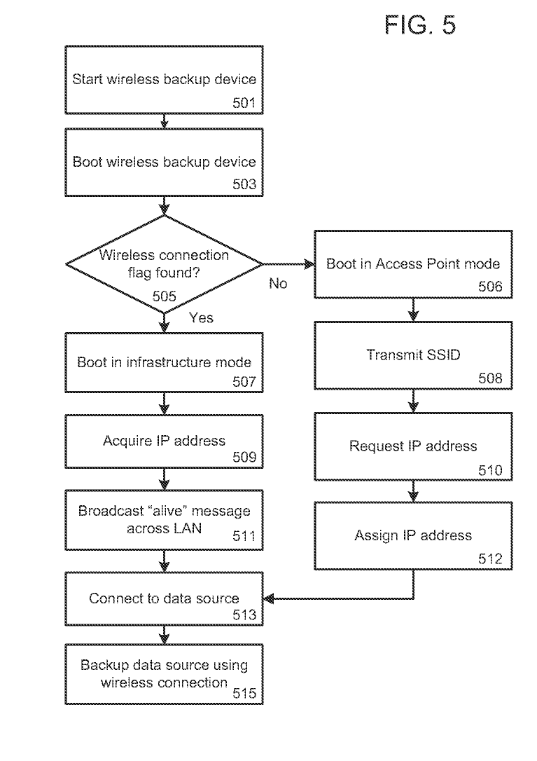

Referring now to FIG. 5, another exemplary method of some portions of the operations described with reference to FIGS. 1-3 according to one embodiment will now be described. In step 501, wireless backup device 101 is started. Starting backup device 101 can occur either via some user input such as pushing a button, an internal schedule, a wakeup call from an external device or some other such mechanism as is known in the art. In response, in step 503, a boot operation of an operating system of wireless backup device 101 occurs which checks for a configuration flag for a computer, such as computer 103, as may have been set in step 411 of FIG. 4.

If in decision block 505 a configuration flag is not found then the operating system of wireless backup device 101 boots in a newly formed wireless access point network mode in step 506. Wireless backup device 101 then wirelessly transmits a Service Set Identifier (SSID) signal in step 508. Upon receiving the wirelessly transmitted SSID signal, the backup application on computer 103 responds by requesting an Internet Protocol (IP) address from wireless backup device 101 in step 510. Wireless backup device 101 then assigns and communicates an IP address to computer 103 in step 512. This sequence of operations serves to establish the newly formed wireless access point network for communication between wireless backup device 101 and computer 103.

Alternatively, if in decision block 505 a configuration flag is found then the operating system of wireless backup device 101 boots in a pre-existing wireless infrastructure network mode in step 507. Wireless backup device 101 then acquires an IP address from a router such as router 113 via wireless basestation 111 in step 509. Wireless backup device 101 then broadcasts a message across the pre-existing wireless infrastructure network indicating that it is alive in step 511.

In step 513 the wireless backup device 101 then wirelessly connects to computer 103 via either the pre-existing wireless infrastructure network or the newly formed wireless access point network. Then, in step 515, the backup application backs up files from computer 103 wirelessly to wireless backup device 101 using whichever wireless connection has been established. Again, as previously explained and dependent upon implementation design choice, this backup operation can be either an initial backup operation or a subsequent incremental backup.

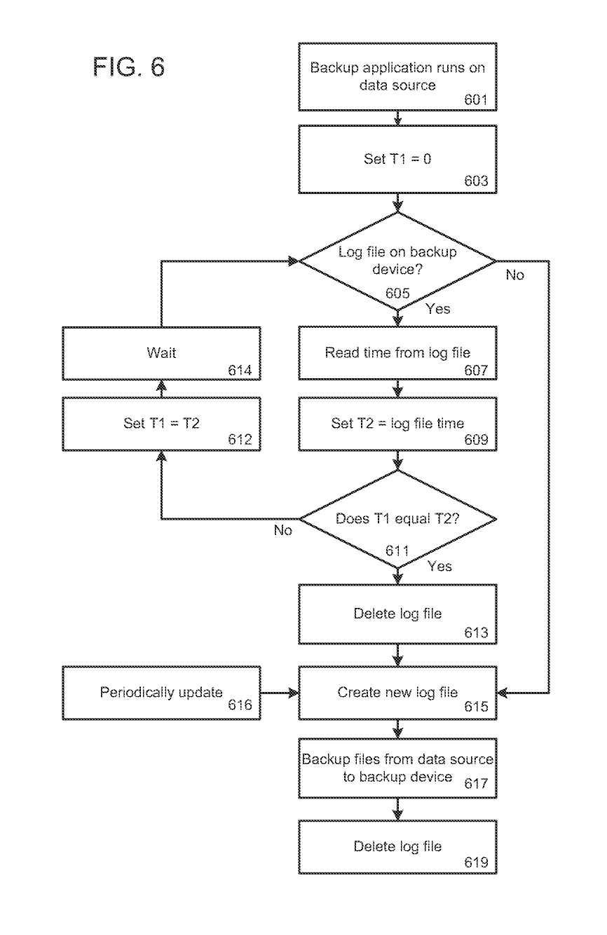

It is to be understood that the method described with respect to FIGS. 4 and 5 can also be performed with respect to one or more other computers such as computers 105-109 of FIGS. 1-3. As such, conflicts can occur when backup operations are attempted for more than one computer at the same time. Such conflicts can be avoided using various techniques. An example of one such technique will now be described with reference to FIG. 6 where a backup application is running on, for example, computer 105 in step 601. The backup application sets a timer, denoted T1, to a zero value in step 603. The backup application checks, via an already established wireless connection with wireless backup device 101 (as may have occurred via the operations described with reference to FIGS. 4 and 5), whether a log file already exists on wireless backup device 101 thus indicating that some other computer is presently performing a backup operation to wireless backup device 101.

If, in decision block 605, it is determined that a log file does not already exist on wireless backup device 101 then, in step 615, the backup application creates a log file containing a time stamp and the name of computer 105 which newly created log file is communicated to and stored on wireless backup device 101. The time stamp of the log file is periodically updated in step 616, for example, every 5 seconds, using, for example a cron operation as is known in the art. Then, in step 617, the backup application backs up files from computer 105 to wireless backup device 101 using whichever wireless connection has been established. The log file is then deleted from wireless backup device 101 in step 619.

Alternatively, if it is determined in decision block 605 that a log file does already exist on wireless backup device 101 then the time stamp from the log file is read in step 607. In step 609 a timer denoted T2 is then set by the backup application to the time read from the time stamp. Then, if it is determined in decision block 611 that timer T1 is equal to timer T2 (thus indicating that although a log file exists on wireless backup device 101 for some other computer, that other computer is not actively backing up to wireless backup device 101), then the log file is deleted from wireless backup device 101 in step 613 and the process proceeds to step 615 to perform the operations as described above. However, if it is determined in decision block 611 that timer T1 is not equal to timer T2 (thus indicating that the existing log file is for some other computer that is actively backing up to wireless backup device 101), then, in step 612, the backup application sets the value of timer T1 to be that of timer T2 (the log file time read in step 607). A configurable period is then allowed to pass (a “wait” period) in step 614 before returning to decision block 605 to once again determine whether a log file currently exists on wireless backup device 101.

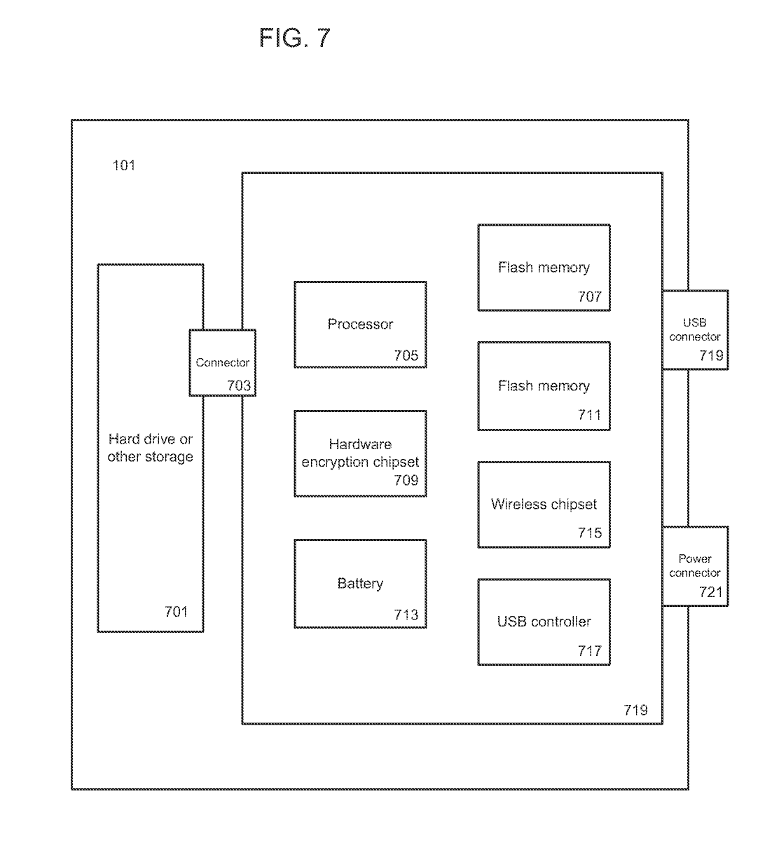

Referring now to FIG. 7, a block diagram can be seen of the various components of wireless backup device 101 according to one embodiment. In this embodiment, wireless backup device 101 includes a hard drive or other storage memory 701 coupled via a connector 703 to a printed circuit board 719. Printed circuit board 719 electrically couples a processor 705, a hardware encryption chipset 709, a battery 713, flash memory 707, additional flash memory 711, a wireless chipset 715, a Universal Serial Bus (USB) controller 717, a USB connector 719 and a power connector 721.

Processor 705 of wireless backup device 101 preferably comprises a Central Processing Unit (CPU) or micro-controller to process and am an operating system (OS) kernel, for example, a minimal-functionality or stripped-down operating system such as a Linux OS kernel.

Flash memory 707 preferably has two or more partitions, one formatted like a CD-ROM to emulate an autorun device and one for storing the backup application and configuration data. Additional flash memory 711 stores the OS kernel. It is to be understood that flash memory 707 and flash memory 711 can be implemented as a single flash memory unit instead of the two discreet units shown in the figure.

Hard drive or other storage memory 701 is used to store the backed up files from computers, such as any of computers 103-109, and hardware encryption chipset 709, optionally included in some embodiments, can be used to encrypt the backed up files to better keep them safe.

Wireless chipset 715 is used for the wireless connections described herein.

USB controller 717 is coupled to USB connector 719 for hardwired communication between wireless backup device 101 and a computer such as any of computers 103-109.

Power connector 721 is used to provide external power to wireless backup device 101 which can be used to recharge optional battery 713 for continued operation of wireless backup device 101 in the absence of such external power source.

Referring again to FIG. 4 and in particular step 409, a process of extracting wireless network settings will now be explained in one embodiment. In some operating systems, such as in Microsoft Windows operating systems the native Wi-Fi Application Programming Interface (API) that contains functions, structures, and enumerations that support wireless network connectivity and wireless profile management can be used for the extraction of information. Further, the API can be used for a pre-existing wireless infrastructure network as well as for a newly-formed wireless ad hoc network.

In one embodiment, a master list of pre-existing wireless infrastructure networks is maintained by the wireless backup device by saving to a list each configured pre-existing wireless infrastructure network connection identified between decision blocks 405 and 407 of FIG. 4 as the wireless backup device is hardwire connected to one or more computers. This list can be stored in flash memory or on the hard drive or other storage memory of the wireless backup device so that it can then be used in the operations described with reference to FIG. 5 and in particular with steps 509-511.

In one embodiment, the wireless backup device scans its surroundings for pre-existing wireless infrastructure networks and attempts to connect to the one with the strongest signal before attempting to connect to one with, a weaker signal. In a further embodiment, should the wireless backup device not be able to connect to any of the pre-existing wireless infrastructure networks then the wireless backup device attempts to connect via a newly-formed wireless ad hoc network connection. In a still further embodiment, the wireless backup device first attempts to connect via a pre-existing wireless infrastructure network and if not able then attempts to connect via a newly-formed wireless access point network connection and if not able then attempts to connect via a newly-formed wireless ad hoc network connection.

In one embodiment the backup operation starts immediately after a large file or a user designated file is saved on a computer. In yet another embodiment, the backup operation starts immediately after a configurable number of files have been saved on a computer. In another embodiment the backup operation starts after the saved data on a computer reaches a certain user configurable size (e.g., 100 MB).

In one embodiment, the files are backed up based on a schedule either pre-configured in the backup software by the manufacturer or user configurable. In one embodiment, the user can schedule a backup time for either one or all computers, and they are backed up as per the schedule set by the user.

In one embodiment, the backup from the computers connected to the pre-existing wireless infrastructure network to the wireless backup device is a continuous backup process. In such a scenario, the files are backed to the wireless backup device essentially as soon as they are changed or saved on the computers.

In one embodiment the user can initiate the backup process for any computer connected to the pre-existing wireless infrastructure network by using a Graphical User Interface (GUI) of the backup application software.

In one embodiment, the backup application software has the intelligence to selectively search the computer for digital files to be backed up based on a certain criteria, e.g., by file extension, which may be user modifiable via a GUI. Thus the software preferably has a pre-defined list of most prevalent file extensions of data files built-in (i.e., included in the backup application software by the manufacturer) and optionally the user may choose to add to or modify this list preferably using a GUI.

In the Microsoft Windows Vista operating system (OS) unlike earlier versions of Microsoft's OSs (e.g., Windows XP, Windows 2000 etc.), a larger number of external and internal devices can use the native AutoRun functionality of the operating system. Up to Microsoft Windows XP, a CD-ROM and a Floppy Drive were the only two devices which were allowed by the OS to execute the AutoRun functionality and devices like external hard drives and USB Flash Drives were unable to make use of this functionality and had to “emulate” as a CD-ROM or a Floppy Drive to “fool” the earlier Microsoft Windows operating systems into thinking that an AutoRun enabled device (e.g. a CD-ROM) had been connected to it.

With Microsoft Windows Vista any external device that reports itself as a “removable” device can take advantage of the AutoRun functionality. Thus in one embodiment, to take advantage of this feature in Microsoft Windows Vista, the backup device reports itself as a “removable” device, triggering the AutoRun functionality which launches the software application initiating the extraction of the digital files from the computer to the wireless backup device for backup.

The computer as referred to herein, especially in the described embodiments, is typically a personal computer with a set of electronic data files to be backed-up. However, such computer can be any data source and is not limited to the examples cited herein and could be a home personal computer (PC), corporate PC, a server, a laptop, a set-top box, an Apple Macintosh computer, a cellular phone, a smartphone, a personal digital assistant (PDA), a personal video recorder (PVR), etc., running any number of different operating systems as diverse as the Microsoft Windows family, the Apple Macintosh Operating System (MacOS), any variation of Linux or Unix, Palm Computing Operating System (PalmOS), or such operating systems used for such devices available in the market today or the ones that will become available as a result of the advancements made in such industries.

The examples noted here are only for illustrative purposes and there may be further embodiments possible with a different set of components. While several embodiments are described, there is no intent to limit the disclosure to the embodiment or embodiments disclosed herein. On the contrary, the intent is to cover all alternatives, modifications, and equivalents obvious to the ones familiar with the art.

In one embodiment, the user flagged files are backed up before others files. Thus all user flagged files from all computers are backed up before all other files are backed up. There may be combinations of the above embodiments and the intent is to cover all combinations that are apparent to ones skilled in the art. Similarly, the exact sequences of the various operations described herein may be altered based on design choice so long as the underlying method and functionality is not altered in a way that would create an incorrect result or eliminate a needed dependency.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A data backup method comprising:
scanning a first computer using a backup software application to determine whether the first computer has a configured pre-existing wireless infrastructure network connection in use by the first computer to a pre-existing wireless infrastructure network;
establishing a wireless network connection between a wireless backup device and the pre-existing wireless infrastructure network if the first computer has a configured pre-existing wireless infrastructure network connection in use by the first computer;
and
automatically and without user input backing up data from the first computer to the wireless backup device across the established wireless network connection between the wireless backup device and the pre-existing wireless infrastructure network using the backup software application if the first computer has a configured pre-existing wireless infrastructure network connection in use by the first computer.

2. The method of claim 1 further comprising:
creating a newly formed wireless network if the first computer does not have a configured pre-existing wireless infrastructure network connection in use by the first computer;
establishing a wireless network connection between the wireless backup device and the first computer via the newly formed wireless network if the first computer does not have a configured pre-existing wireless infrastructure network connection in use by the first computer;
and
automatically and without user input backing up data from the first computer to the wireless backup device across the established wireless network connection between the wireless backup device and the first computer via the newly formed wireless network using the backup software application if the first computer does not have a configured pre-existing wireless infrastructure network connection in use by the first computer.

3. The method of claim 1 further comprising automatically and without user input launching, installing and configuring the backup software application from the wireless backup device via an autorun operation triggered by a hardwired connection between the first computer and the wireless backup device before the step of scanning the first computer using the backup software application.

4. The method of claim 1 further comprising launching the backup software application from the wireless backup device to the first computer and automatically and without user input installing and configuring the backup software application on the first computer before the step of scanning the first computer using the backup software application.

5. The method of claim 1 further comprising launching the backup software application from an optical disc to the first computer and automatically and without user input installing and configuring the backup software application on the first computer before the step of scanning the first computer using the backup software application.

6. The method of claim 1 further comprising launching the backup software application downloaded from another computer across a network to the first computer and automatically and without user input installing and configuring the backup software application on the first computer before the step of scanning the first computer using the backup software application.

7. The method of claim 1 wherein the step of scanning the first computer using the backup software application to determine whether the first computer has a configured pre-existing wireless infrastructure network connection in use by the first computer to a pre-existing wireless infrastructure network further comprises extracting information using a wireless network application programming interface of an operating system of the first computer.

8. The method of claim 7 further comprising saving to the wireless backup device the extracted information.

9. The method of claim 8 wherein the saved extracted information includes information about the pre-existing wireless infrastructure network.

10. The method of claim 1 wherein the step of creating a newly formed wireless network further comprises creating a wireless ad hoc network.

11. The method of claim 1 wherein the step of creating a newly formed wireless network further comprises creating a wireless access point network.

12. The method of claim 1 wherein the step of automatically and without user input backing up data from the first computer to the wireless backup device across the established wireless network connection between the wireless backup device and the pre-existing wireless infrastructure network using the backup software application further comprises the backup software application first checking the wireless backup device for a possible conflict with a second computer currently backing up data to the wireless backup device before performing the step of backing up data from the first computer to the wireless backup device.

13. The method of claim 1 wherein the step of automatically and without user input backing up data from the first computer to the wireless backup device across the established wireless network connection between the wireless backup device and the first computer via the newly formed network using the backup software application further comprises the backup software application first checking the wireless backup device for a possible conflict with a second computer currently backing up data to the wireless backup device before performing the step of backing up data from the first computer to the wireless backup device.

14. The method of claim 1 further comprising:
automatically and without user input installing and configuring the backup software application on a second computer;
scanning the second computer using the backup software application to determine whether the second computer has a configured pre-existing wireless infrastructure network connection in use by the second computer to a pre-existing wireless infrastructure network;
establishing a wireless network connection between the wireless backup device and the pre-existing wireless infrastructure network if the second computer has a configured pre-existing wireless infrastructure network connection in use by the second computer;
creating a newly formed wireless network if the second computer does not have a configured pre-existing wireless infrastructure network connection in use by the second computer;
establishing a wireless network connection between the wireless backup device and the second computer via the newly formed wireless network if the second computer does not have a configured pre-existing wireless infrastructure network connection in use by the second computer;
automatically and without user input backing up data from the second computer to the wireless backup device across the established wireless network connection between the wireless backup device and the pre-existing wireless infrastructure network using the backup software application if the second computer has a configured pre-existing wireless infrastructure network connection in use by the second computer;
and
automatically and without user input backing up data from the second computer to the wireless backup device across the established wireless network connection between the wireless backup device and the second computer via the newly formed wireless network using the backup software application if the second computer does not have a configured pre-existing wireless infrastructure network connection in use by the second computer.

15. A method of computer data backup, the method comprising:
automatically and without user input launching, installing and configuring a backup software application from a wireless backup device to a first computer upon detection by the first computer of a wired connection between the wireless backup device and the first computer;
automatically and without user input launching, installing and configuring the backup software application from the wireless backup device to a second computer upon detection by the second computer of a wired connection between the wireless backup device and the second computer;
automatically and without user input backing up data from the first computer and the second computer to the wireless backup device across a pre-existing wireless infrastructure network using the backup software application if the first computer and the second computer each have a configured pre-existing wireless infrastructure network connection in use:
and
automatically and without user input backing up data from the first computer and the second computer to the wireless backup device across a newly formed wireless network between the wireless backup device, the first computer and the second computer using the backup software application if the first computer and the second computer each do not have a configured pre-existing wireless infrastructure network connection in use.

16. The method of claim 15 wherein the newly formed wireless network is a wireless ad hoc network.

17. The method of claim 15 wherein the newly formed wireless network is a wireless access point network.

18. A non-transitory computer readable medium containing programming code executable by a processor, the programming code configured to perform a method comprising:
automatically and without user input installing and configuring a backup software application on a first computer;
scanning the first computer using the backup software application to determine whether the first computer has a configured pre-existing wireless infrastructure network connection in use by the first computer to a pre-existing wireless infrastructure network;
establishing a wireless network connection between a wireless backup device and the pre-existing wireless infrastructure network if the first computer has a configured pre-existing wireless infrastructure network connection in use by the first computer;
creating a newly formed wireless network if the first computer does not have a configured pre-existing wireless infrastructure network connection in use by the first computer;
establishing a wireless network connection between the wireless backup device and the first computer via the newly formed wireless network if the first computer does not have a configured pre-existing wireless infrastructure network connection in use by the first computer;
automatically and without user input backing up data from the first computer to the wireless backup device across the established wireless network connection between the wireless backup device and the pre-existing wireless infrastructure network using the backup software application if the first computer has a configured pre-existing wireless infrastructure network connection in use by the first computer;
and
automatically and without user input backing up data from the first computer to the wireless backup device across the established wireless network connection between the wireless backup device and the first computer via the newly formed wireless network using the backup software application if the first computer does not have a configured pre-existing wireless infrastructure network connection in use by the first computer.
